(19) United States
(12) Patent Application Publication
(10) Pub. No.: US 2025/0164674 A1
(43) Pub. Date: May 22, 2025

(54) Reflective Surface for a Photochemistry Chamber

(71) Applicant: 12180235 Canada Ltd., CentrePort (CA)

(72) Inventors: David Prystupa, Pinawa (CA); John Pacak, Winnipeg (CA)

(21) Appl. No.: 18/729,001

(22) PCT Filed: Jan. 13, 2023
(86) PCT No.: PCT/CA2023/050038

§ 371 Date: Jul. 15, 2024

Related U.S. Application Data
(60) Provisional application No. 63/299,535, filed on Jan. 14, 2022.

(51) Int. Cl. G02B 5/08

(52) U.S. Cl. CPC G02B 5/0891; G02B 5/0816

(57) ABSTRACT

A surface covering or film for reflecting UVC or NIR radiation can be applied as a covering on a wall of a chamber includes a substrate with a smooth front surface overlain by a stack of parallel dielectric bilayers of different refractive index so that the stack forms a reflective layer at a selected range of wavelengths. The film can include an integral radiation source. A thermal insulation layer can be included to reduce conductive energy loss. The film can include decorative features at visible wavelengths that minimally affect the reflectivity of the stack at UVC or NIR wavelengths. A control device functions to activate or inactivate radiation sources, to apply voltages to selected regions of a reflective film or array of reflective films, and/or to receive and process sensor inputs. The stack is underlain by regions of electrically conductive material at different voltages. The film can be formed into individual tiles applied edge to edge.

### RELATED APPLICATIONS

This disclosure is related to disclosures relating to a Multipass Photochemistry System, hereafter “MPS patent” by the present inventors described in PCT Application PCT/CA2021/050976 filed Jul. 15, 2021 claiming an earliest priority date of Jul. 17, 2020 published on or around Jan. 17, 2022. The disclosures of this application are incorporated herein by reference or may be referenced by attention to a copy of the application as filed. This application discloses a number of embodiments of reflective surfaces and vessels using those surfaces where the disclosures and improvements set out in the present application can find advantage.

The invention relates to a method for constructing reflective surfaces of a photochemistry chamber and to the construction of the reflective surface.

Also, this disclosure is related to disclosures in PCT/CA2022/051397 filed Sep. 21, 2022 relating to a Method for controlling radiation from a source, hereafter “MPS2 patent” by the present inventors. The disclosures of this application are incorporated herein by reference or may be referenced by attention to a copy of the application as filed. This application discloses a number of embodiments of reflective surfaces and vessels using those surfaces where the disclosures and improvements set out in the present application can find advantage.

### BACKGROUND OF THE INVENTION

Photochemistry reaction chambers may include curved surfaces that optimize photonic efficiency. For example the above cited MPS patent and MPS2 patent describe geometric configurations that include curved reflective surfaces to optimize optical amplification and hence photonic efficiency. The reflective curved surfaces work best with an optical quality polish that requires a costly high precision manufacturing process that involves both three dimensional polishing and a three dimensional dielectric layer deposition process. A high quality three dimensional optical surface may cost more than $10 and up to $50 per square centimeter to manufacture with conventional methods. The high cost of manufacturing limits the range of applications that are economically viable for photochemistry reaction chambers. There is hence a need for a method of production of reflective optical surface at low cost to expand the range of economically viable applications.

### SUMMARY OF THE INVENTION

The invention is a method for constructing reflective surfaces for NIR and UV photochemistry chambers based on designs described in the above mentioned MPS patent. The reflective surfaces may include decorative features at visible wavelengths that minimally affect the reflectivity at design NIR or UV wavelengths. Unless otherwise specified, all reflectivity specifications herein refer to the reflectivity for a wavelength selected from the UVC range between 180 nm and 320 nm or the NIR range between 800 nm and 1800 nm.

The working range of a UVC photochemistry reaction chamber may be narrower, for example between 240 nm and 280 nm or between 180 nm and 230 nm. The working range of a NIR photochemistry reaction chamber may be broader, for example between 800 nm and 1800 nm or between 700 nm and 2000 nm. The photochemistry reaction chamber is comprised of structural materials that support the geometric shape of the reaction chamber and a reflective film that is shaped to conform to the general shape of the structural materials. The general shape of the photochemistry reaction chamber may for example be selected from the shapes described in the above cited MPS patent. The general shape of the photochemistry reaction chamber may for example be selected from the geometric forms described herein. Less preferably, the general shape of the photochemistry reaction chamber may be a conventional design.

According to one feature of the invention which can be used with any of the other features defined herein the reflective film is comprised of a substrate with a front surface and a back surface wherein the front surface faces the direction of incident radiation and the back surface faces away from incident radiation. The front surface is fabricated to have a substantially smooth surface to minimize reflection at non-specular angles. The reflectivity of a surface is described by the bidirectional reflectance function (BDRF) that gives the angular distribution of energy reflected for a given angle of incidence. Non-specular reflection is taken herein to refer to radiation reflected at angles of reflection that are different than the average angle of incidence by more than the angular divergence of the incident radiation. For example, an incident beam with angular divergence of 20 milliradians is reflected from a surface and the portion of energy reflected at an angle of reflection that is within 20 milliradians of the central or average angle of incidence is considered to be reflected specularly and the portion of energy reflected at angles of reflection that differ by more than 20 milliradians from the angle of incidence are considered to be reflected non-specularly. For the reflective film of the invention, the non-specular reflection amounts to less than 50% of the reflected energy.

The substrate provides mechanical support for layers that may be deposited on the front and back surfaces as discussed below. The substrate may for example be comprised of a metal foil, a plastic film, glass fiber fabric, or thin glass. The substrate thickness is typically in the range of 10 microns to 200 microns, but thicker substrates 1000 microns or more may be used for applications requiring greater mechanical rigidity.

According to a further aspect of the invention there is provided a reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the reflective surface covering includes an integral radiation source.

According to a further aspect of the invention there is provided a reflective surface covering applied to a chamber surface for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein a thermal insulation layer is placed on a surface of the substrate so that the stack functions to reduce radiative energy loss and the thermal insulation layer functions to reduce conduction of heat energy.

According to a further aspect of the invention there is provided a reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the reflective surface includes decorative features at visible wavelengths that minimally affect the reflectivity of the stack at said selected range of wavelengths.

According to a further aspect of the invention there is provided a reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the reflective surface covering is in communication with a control device that functions to activate or inactivate radiation sources, to apply voltages to selected regions of a reflective film or array of reflective films, and/or to receive and process sensor inputs.

According to a further aspect of the invention there is provided a reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the stack is underlain by a plurality of separate regions of electrically conductive material wherein each conductive region is in communication with a voltage source via conductive traces and wherein at least two regions are held at different voltages.

According to a further aspect of the invention there is provided a reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the surface covering is formed into individual tiles.

Preferably the non-specular reflection amounts to less than 10% of the reflected energy. Most preferably, the non-specular reflection amounts to less than 1% of the reflected energy.

The amount of non-specular reflection correlates with the surface roughness or deviation from the mean surface profile relative to the wavelength of incident radiation. In practice the root mean square (RMS) deviation from the average front surface profile should be less than a wavelength of the incident radiation, more preferably less than one quarter of a wavelength of the incident radiation and most preferably less than one twentieth of a wavelength of the incident radiation. For example, if the selected wavelength of UVC radiation is 240 nm, the preferred and most preferred RMS deviations are 60 nm and 12 nm, respectively. For example, if the selected wavelength of NIR radiation is 1200 nm, the preferred and most preferred RMS deviations are 300 nm and 60 nm, respectively.

For example for a NIR design wavelength of 1200 nm, each dielectric layer has an optical thickness of 300 nm. The physical thickness is the optical thickness divided by the refractive index. For example, if the refractive indices of A and B are 1.4 and 1.6, respectively, the physical thickness of 5 bilayers is 2 microns. For a UV design wavelength of 300 nm, the physical thickness of 5 bilayers is 0.5 microns in this example. Hence the overall thickness of a thin 10 micron substrate plus dielectric stack is 12 microns or less.

According to one feature of the invention which can be used with any of the other features defined herein, the smooth front surface of the film substrate is overlain with a sequence of dielectric layers that collectively comprise a dielectric mirror for a selected wavelength, or range of wavelengths. The dielectric layers are comprised of at least two different materials selected to have different refractive indexes and low absorption at the selected wavelength or range of wavelengths.

The first dielectric material A has a higher refractive index than the second dielectric material B. Alternating layers of A and B overlay the smooth front surface film substrate with the optical thickness (refractive index times thickness) of each layer being approximately one quarter of the selected wavelength. This condition is known to those skilled in the art to produce constructive interference and high reflectivity that increases with the number n of alternating bilayers AB. The number of layers required for a desired reflectivity decreases as the difference in refractive index between A and B increases. Hence it is desirable, but not necessary to select materials with refractive indexes as far apart as possible that are compatible with a fabrication process.

Most preferably the layers are added with the high refractive index layer A proximate to the smooth substrate S such that the pattern is S(AB)ⁿ. The material A may for example be ZrO2 or HfO2 with refractive index of about 2.3 and the material B may for example be SiO2 with refractive index about 1.5. For n=4, the reflectivity is about 99.9% near normal incidence. Other materials may be used for A and B. Further, a different dielectric material A1 may be substituted for A at one or more A positions in the sequence 30 provided that the refractive index of A1 is greater than the refractive index of B. Further a different dielectric material B1 may be substituted for B at one or more B positions in the sequence provided that the refractive index of B1 is less than the refractive index of A.

According to one optional feature of the invention which can be used with any of the other features defined herein, a metallic layer M is placed between the smooth front surface of the substrate and the sequence of dielectric layers. In this case the sequence of layers is SM(AB)ⁿ. In some embodiments the metallic layer is a reflective layer with sufficient thickness that radiation at the selected wavelength does not penetrate the metallic layer. The metallic layer may for example be aluminum which is more reflective than other metals for wavelengths between 180 nm and 280 nm. The metallic layer may for example be gold which is more reflective than other metals for infrared wavelengths. In these embodiments, the aluminum or gold layer works together with the dielectric layers to increase the overall reflectivity at the selected wavelength or wavelength range. In other embodiments, the metallic layer is selected to produce an optical effect at visible wavelengths between 400 nm and 700 nm. For example, the metallic layer may be copper which reflects more at red wavelengths (650 nm) than blue wavelengths (450 nm) giving a red hue. Those skilled in the art will appreciate that the thickness of the metallic layer affects the reflectivity and hence appearance in the visible region (400 nm to 700 nm). Those skilled in the art will also recognize that some choices of the metallic layer M may cause a decrease the overall reflectivity at the selected UVC or NIR wavelength. That is there is a trade-off between performance at the selected UVC or NIR wavelength and a desired effect at visible wavelengths.

According to one optional feature of the invention which can be used with any of the other features defined herein, a pigment layer P is placed between the smooth front surface of the substrate and the sequence of dielectric layers. In this case the sequence of layers is SP(AB)ⁿ. The pigment layer is selected to produce a desired color effect at wavelengths in the visible region between 400 nm and 700 nm. Those skilled in the art will also recognize that some choices of the pigment layer P may cause a decrease the overall reflectivity at the selected UVC or NIR wavelength. That is there is a trade-off between performance at the selected UVC or NIR wavelength and a desired effect at visible wavelengths.

According to one optional feature of the invention which can be used with any of the other features defined herein, the smooth substrate is selected to be transparent or translucent at visible wavelengths between 400 nm and 700 nm and a metallic layer M is placed on the back surface of the substrate. In this case the sequence of layers is MS(AB) n. In this embodiment, the metallic layer is selected to produce an optical effect at visible wavelengths between 400 nm and 700 nm. For example, the metallic layer may be gold which reflects more at red wavelengths (650 nm) than blue wavelengths (450 nm) giving a red hue. Those skilled in the art will appreciate that the thickness of the metallic layer affects the reflectivity and hence appearance in the visible region (400 nm to 700 nm).

According to one optional feature of the invention which can be used with any of the other features defined herein, an insulating pigment layer P is placed on the back surface of the substrate. In this case the sequence of layers is PS(AB)ⁿ. In this embodiment, the pigment layer is selected to produce an optical effect at visible wavelengths between 400 nm and 700 nm.

According to one optional feature of the invention which can be used with any of the other features defined herein, a thermal insulation layer T is placed on the back surface of the substrate. In this case the sequence of layers is TS(AB)ⁿ. In this embodiment, the dielectric layers (AB)ⁿ function to reduce radiative energy loss from the chamber interior (typically at NIR wavelengths) and the thermal insulation layer functions to reduce conduction of heat energy from the chamber interior. The thermal insulation layer may for example be comprised of two solid surfaces separated by a gap. In some embodiments, one of the surfaces may be the back side of the substrate layer. The gap may be maintained by an array of spacer elements with low thermal conductivity. Preferably the spacer elements follow a folded or torturous path such that the path length along the spaces between surfaces is at least twice the distance between the surfaces. Preferably the path length along the spacers is more than ten times the distance between the surfaces. The gap region may be kept at low pressure (vacuum), filled with a high atomic mass gas such as argon, or filled with an aerogel.

The thermal insulation layer T may optionally include reflective surfaces to reduce emissivity of black body radiation.

For thermal applications, reducing emissivity improves performance. Rather than add a reflective layer to the substrate separately, the reflective layer(s) required are defined to be part of the thermal insulation layer.

According to one optional feature of the invention which can be used with any of the other features defined herein, the substrate is divided into a plurality of different spatial regions and at least two of said spatial regions have one layer of metal or pigment applied and wherein the metal or pigment applied to each spatial region is different. In some embodiments the metal or pigment is applied to the smooth front surface of the substrate. In other embodiments the substrate material is transparent or translucent at visible wavelengths between 400 nm and 700 nm and the metal or pigment is applied to the back surface of the substrate. For example, the pattern of pigments applied to different spatial regions of the substrate may reproduce a decorative reproduction of an art work such as the Mona Lisa. The decorative pattern may convey information in the form of letters and numbers (an Exit sign or part number for example) or in the form of a digital pattern such as a QR code.

According to one optional feature of the invention which can be used with any of the other features defined herein, an attachment means is applied to the back surface of the substrate (or metal, pigment, or thermal insulation layer attached to the back surface of the substrate). The attachment means for example may be an adhesive that binds the substrate (and overlying reflective layers) to a surface. The attachment means may for example be a block of material that includes a threaded hole arranged such that the substrate may be attached to a frame with a screw or like fastener. The attachment means may for example have an outwardly projecting shape that binds with a complimentary shape on a frame. The attachment means for example may be an adhesive.

According to one optional feature of the invention which can be used with any of the other features defined herein, a coating layer C overlays the sequence of dielectric materials wherein the coating layer C is substantially transparent to UVC or NIR radiation at the selected wavelength or wavelength range. The coating layer C serves to protect the dielectric layers A and B from mechanical damage and from the ingress of unwanted gasses (such as water vapor) or unwanted solvents (such as a cleaning solution). The optical thickness of the coating layer C is selected to have minimal effect on the reflectivity of the underlying dielectric stack. This is accomplished in practice by making the coating layer either optically much thicker than the dielectric layers A and B or optically much thinner (ie half or less than half of the optical thickness of layers A and B).

According to one optional feature of the invention which can be used with any of the other features defined herein, the reflective film comprised of the substrate, dielectric layers, and optional features described above is flexible and can be bent elastically with a radius of curvature at or above a threshold radius of curvature. A reflective film may be designed for example with a threshold radius of curvature of Rc less than the radius of a cylindrical duct in a reaction chamber. The reflective film is cut to the length of the duct and a width that corresponds with the circumference of the duct and the width dimension is wound into a coil with radius greater than Rc and less than the radius of the cylindrical duct. The coil is placed in the duct and elastically expands to conform to the duct radius. Embodiments of the reflective film including a thermal insulation layer may be used for example to retrofit residential and commercial buildings for improved energy efficiency.

According to one optional feature of the invention which can be used with any of the other features defined herein, the substrate of the reflective film is rigid and substantially planar: that is the radius of curvature is greater than 10 meters. In some embodiments, a thin flexible film is fabricated and applied to a rigid block to form a planar reflector. In other embodiments the rigid block is integral with the substrate material.

According to one optional feature of the invention which can be used with any of the other features defined herein, the reflective film is cut into a plurality of sections and the sections are assembled abutting or nearly abutting to form a multi-faceted three dimensional optical surface. For example, a concave parabolic mirror may be assembled from a set of mirror film sections with small gaps between sections.

According to one optional feature of the invention which can be used with any of the other features defined herein, the reflective film is formed to and bonded to a three dimensional surface. For example the reflective film may be heated and vacuum formed to a three dimensional surface such as a concave mirror. This feature allows a three dimensional optical element to be constructed from a two dimensional film. This has the advantage of doing most of the fabrication steps in two dimensions with less cost than fabricating an equivalent optical element in a three dimensional process.

According to one optional feature of the invention which can be used with any of the other features defined herein, the reflective film is formed to produce at least two opposing surfaces of a photochemistry reaction chamber wherein the radius of curvature of a first opposing surface R1 and the radius of curvature of a second opposing surface R2 are related to the distance L between the centers of the opposing surfaces by the relation 0<= (1−L/R1)*(1−L/R2)<=q where q is a real number where q is less than 4. The value of q is determined by the effect of side walls of the reaction chamber as described in the above cited MPS patent. The inventors determined empirically by simulation that q is less than 4. A better value can be determined by simulation. More preferably q is less than 2. Most preferably q is equal to 1, which corresponds to the theoretical limit for an optical cavity without side walls.

According to one optional feature of the invention which can be used with any of the other features defined herein, the reflective film is cut into a plurality of sections and the sections are assembled in a three dimensional connected network. For example, the three dimensional network may include sections that resemble leaves, stems and flowers of a plant. The three dimensional network of reflective surfaces resembling a plant increases surface area, which may be advantageous for electrostatic particulate removal from air. Further, the three dimensional surfaces may discretely include opposed reflective surfaces that amplify the effect of UVC sterilization as discussed in the above cited MPS patent by the current inventors.

According to one optional feature of the invention which can be used with any of the other features defined herein, the reflective film is applied to at least one interior surface of a room and a source of UVC radiation at the selected wavelength is added to the room. Preferably the walls and ceiling of the room are covered with the reflective film. More preferably the floor of the room is also covered with the reflective film. The reflective film functions in reduce the time required to sterilize the room by increasing the path length of UVC rays at the selected wavelength or wavelength region. The room may for example be an operating room in a hospital. The room may for example be in a food processing facility. The room may for example be in a pharmaceutical manufacturing facility.

According to one optional feature of the invention which can be used with any of the other features defined herein, the reflective film is applied to at least one interior surface of a room and a source of UVC radiation at the selected wavelength is added to the room. The reflective film herein is understood to retain UVC radiation within the room: that is the front surface of the reflective dielectric stack is directed inward into the room. Preferably the walls and ceiling of the room are covered with the reflective film. More preferably the floor of the room is also covered with the reflective film. The wall, ceiling and floor surfaces are herein understood to be opaque to radiation with wavelengths in the visible range (400 nm to 700 nm). In some embodiments, windows transparent to visible wavelengths may be covered with the reflective film with the caveat that the substrate and pigment layers of the reflective film transmit at least 10% of at least one visible wavelength. The reflective film in this embodiment may have the visual appearance of a stained glass window while functioning as a mirror at UVC wavelengths. The reflective film functions to reduce the time required to sterilize the room by increasing the path length of UVC rays at the selected wavelength or wavelength region. The room may for example be an operating room in a hospital. The room may for example be in a food processing facility. The room may for example be in a pharmaceutical manufacturing facility.

According to one optional feature of the invention which can be used with any of the other features defined herein, the reflective film is applied to at least one interior surface of a room containing thermal (NIR) radiation wherein the reflective film is designed to reflect at least one wavelength of thermal (NIR) radiation. Preferably the reflective film includes a thermal insulation layer. Preferably the walls and ceiling of the room are covered with the reflective film. More preferably the floor of the room is also covered with the reflective film. The reflective film functions in reduce radiative and conductive heat loss from the room. The room may for example be in a residential or commercial building.

According to one optional feature of the invention which can be used with any of the other features defined herein, the reflective film includes an integral radiation source. The radiation source may for example emit at a selected UVC wavelength or range of wavelengths and the radiation emitted may be used in combination with the high reflectivity of the reflective film to conduct a photochemical process such as sterilization. The radiation source may for example emit at a visible wavelength and the visible wavelength is used as an indicator of a condition proximate to the reflective film. For example, the indicator light may be activated to indicate that a source of UV radiation is active or about to become active. In some embodiments, the visible light is used for general illumination. In some embodiments a metallic layer described above is patterned to form a network of conductive traces that connect the integral radiation source to an electric power supply. In some embodiments, the reflective film may include an integral NIR radiation source. The NIR radiation source may for example be a LED that emits at a specific range of wavelengths. The NIR radiation source may for example be an electrically resistive conductor that radiates thermal radiation over a broad spectral range and also adds thermal energy to the interior of a chamber via thermal conduction.

According to one optional feature of the invention which can be used with any of the other features defined herein, the reflective dielectric layers are underlain by a plurality of separate regions of electrically conductive material wherein each conductive region is in communication with a voltage source via conductive traces and wherein at least two regions are held at different voltages. The electric field produced at the reflective film surface by each conductive region may function to attract and retain particles to the film surface with electrostatic forces, thereby removing said particles from air proximate to the surface. The particles may for example be virus particles, bacteria particles, pollen particles, allergen particles, skin particles, hair fibers, or mineral particles. This embodiment requires a periodic cleaning of surfaces to remove accumulated particles. Preferably this embodiment also includes UVC radiation sources that function to inactivate particles attracted to the surface. The wavelength of one or more UVC radiation sources may be selected to ionize air and particulate matter in the air. The control means may activate ionizing UVC radiation together with the applied voltages to improve the efficiency of electrostatic particle sequestration.

According to one optional feature of the invention which can be used with any of the other features defined herein, the reflective film includes a sensor operable to detect the amplitude of radiation at a selected wavelength.

According to one optional feature of the invention which can be used with any of the other features defined herein, the reflective film may be in communication with a control means. The control means may for example be a CPU, FPGA, logic circuit, or analog circuit that functions to activate or inactivate radiation sources, to apply voltages to selected regions of a reflective film or array of reflective films, and to receive and process sensor inputs. The sensor inputs may for example be the temperature or the amplitude of radiation at selected wavelengths. The control means may be connected with a communication network and operate to temporally modulate radiation sources at selected wavelengths for the purpose of transmitting data to computation devices proximate to the radiation sources. The control means may be in communication with sensors integral with the reflective film that receive temporally modulated radiation at selected wavelengths from computation devices proximate to the reflective film. The control means may process said sensor signals to extract data transmitted by the proximate computation device. The temporal modulation may be amplitude, phase, polarization, or any combination thereof. The control means may include a user interface that displays information about the activation state of radiation sources or voltages applied, or data received and allows a user to change the state of each.

According to one optional feature of the invention which can be used with any of the other features defined herein, the reflective film includes a sensor operable to detect the amplitude of radiation at a selected wavelength. In some embodiments, the selected wavelength is a UVC wavelength and the sensor measures the amplitude of UVC radiation incident on the reflective surface. In some embodiments the sensor measures thermal radiation, which may for example be used to detect the presence of a human. In some embodiments a metallic layer described above is patterned to form a network of conductive traces that connect the said integral sensor to a computation device operable to generate a logic signal based at least in part on the amplitude measured by the sensor.

The term “film” herein refers to the substrate layer or the substrate layer plus one or more overlain dielectric layers.

In some embodiments, the required smoothness of the film front surface is prepared by polishing the front surface in a lapping process wherein the film is attached to or integral with an optical flat. The film may for example be attached to the optical flat with optical pitch. That is the polishing is done relative to an optically flat two dimensional planar surface.

In some embodiments, the required smoothness of the film front surface is prepared by a casting process wherein the film material is injected into a mould with optically flat surfaces. The mould material may for example be a silicone polymer. The film material is selected to have low viscosity to conform to the mould surface and a long setting time to minimize dimensional changes upon setting. The film material may for example be an epoxy resin comprised of monomers or short chain units of a polymer that polymerize or cross link with the presence of a catalyst or irradiation with UV radiation.

In some embodiments, the required front surface smoothness is prepared by spin coating a coating material onto a substrate material wherein the coating material adheres to the substrate material and minimizes surface energy so as to produce a smooth surface.

In some embodiments, the required smoothness of the film front surface may be prepared by an extrusion process wherein surface tension during the extrusion process minimizes the surface area of the film and hence produces a smooth surface. Films prepared in this manner may be obtained from commercial sources.

In some embodiments, the required smoothness of the film front surface is prepared by floating the film material on a liquid with a smooth surface. For example the film material may be float glass or quartz prepared by floating molten film material on a bed of liquid molten tin.

In some embodiments, the film material is a polymer and the polymer is selected to resist degradation by UVC radiation at and proximate to the selected wavelength between 180 nm and 320 nm. For example, PTFE (Teflon) and related fluorine containing polymers have suitable properties.

In some embodiments, the film material is a polymer and the front surface of the film is overlain with coating that absorbs or reflects UVC radiation between 180 nm and 320 nm such that said radiation incident on the coating layer is not incident on the polymer film front surface. In this embodiment the film material may be any polymer with suitable properties such as mechanical strength and resistance to environmental conditions such as humidity, temperature, chemical contaminants and the like. The coating material is preferably aluminum which may be deposited by vacuum sputtering or by evaporation onto the film in a vacuum. Other coating materials may be used.

In some embodiments, the film material is selected to be transparent for at least some wavelengths in the visible range generally between 400 nm to 700 nm. The film material may for example be quartz, fused silica, glass, glass fiber fabric or a transparent polymer.

In some embodiments, the reflective film material is applied to at least one surface of a thermal radiator device and the applied film material functions to increase the reflectivity of said surface at selected UVC wavelengths. Preferably the applied film material has low reflectivity and high absorption at NIR wavelengths to enhance heat transfer. The reflective film material may for example be applied to the vanes of a radiator in an air conditioning unit. The reflective film operates to increase the amplitude of UVC radiation at the surfaces of the vanes and within the space between the vanes. The UVC radiation may for example be used to inhibit the growth of fungus or other microbes on or proximate to the vane surfaces.

The arrangement herein further provides a surface covering for reflecting UVC radiation wherein at least a portion of the surface bounds the air in a room and wherein the surface covering comprises a planar substrate layer with a back surface including an attachment means and a front surface overlain by a stack of substantially parallel dielectric bilayers wherein each bilayer consists of a first dielectric layer and a second dielectric layer arranged substantially parallel to one another and the substrate material, wherein the first dielectric layer is comprised of a material that has a higher refractive index than the second dielectric layer within the wavelength range from 250 nm to 280 nm and wherein each dielectric layer is substantially transparent at wavelengths between 250 nm and 280 nm and wherein the optical thickness of each dielectric layer is one quarter of a selected wavelength between 250 nm and 280 nm and wherein the bilayers are arranged such that the high refractive index layer of a first bilayer abuts the low refractive index layer of a second bilayer, and wherein the reflectivity of the surface covering at normal incidence is at least 90% for at least one wavelength between 250 nm and 280 nm. More preferably, the reflectivity for at least one wavelength is at least 99%.

Preferably the stack of substantially parallel bilayers further includes a single outer layer comprised of a material that is substantially transparent at wavelengths between 250 and 280 nm and has a refractive index in the 250 to 280 nm range greater than the refractive index of the abutting bilayer material and the optical thickness of said outer layer is approximately one eighth of the selected wavelength.

Selection of a design wavelength in the range 250 nm to 280 nm is suitable for Hg discharge tubes and UVC LED sources. Alternately, the selected design wavelength could be in the range from 210 nm to 230 nm suitable for UV excimer radiation sources operating at a nominal 222 nm wavelength. Other choices of design wavelength with the range from 180 nm to 320 nm are possible, depending on the radiation source.

Preferably the substrate layer is aluminum.

The arrangement herein further provides a surface covering for reflecting NIR radiation wherein at least a portion of the surface bounds the air in a room and wherein the surface covering is comprised a planar substrate layer with a back surface including an attachment means and a front surface overlain by a stack of substantially parallel dielectric bilayers wherein each bilayer consists of a first dielectric layer and a second dielectric layer arranged substantially parallel to one another and the substrate material wherein the first dielectric layer is comprised of a material that has a higher refractive index than the second dielectric layer within the wavelength range from 700 nm to 2000 nm and wherein each dielectric layer is substantially transparent at wavelengths between 700 nm and 2000 nm and wherein the optical thickness of each dielectric layer is one quarter of a selected wavelength between 700 nm and 2000 nm and wherein the bilayers are arranged such that the high refractive index layer of a first bilayer abuts the low refractive index layer of a second bilayer, and wherein the reflectivity of the surface covering at normal incidence is at least 90% for at least one wavelength between 700 nm and 2000 nm. More preferably, the reflectivity for at least one wavelength is at least 99%. Preferably the surface covering includes a thermal insulation layer between the substrate and attachment means.

Preferably the stack of substantially parallel bilayers further includes a single outer layer comprised of a material that is substantially transparent at wavelengths between 700 nm and 2000 nm and has a refractive index in the 700 nm to 2000 nm range greater than the refractive index of the abutting bilayer material and the optical thickness of said outer layer is approximately one eighth of the selected wavelength.

Note that the refractive index is slowly varying at wavelengths far from a strong absorption by the Krammers Kronig relation and hence the refractive index in a narrow range around a selected wavelength is almost the same as the refractive index at the selected wavelength.

Preferably the substrate layer is substantially transparent at wavelengths between 400 nm and 700 nm.

Preferably the substrate layer is comprised of glass or quartz.

Preferably the substrate layer includes a material that absorbs more than 20% of incident radiation for at least one wavelength between 400 nm and 700 nm.

Preferably the substrate layer further includes at least two different materials of the same thickness that absorb radiation between 400 nm and 700 nm differently and wherein the at least two different materials are in spatially distinct regions.

Preferably the spatially distinct regions are arranged to form a decorative pattern and wherein each region in the decorative pattern has a different visual appearance.

Preferably the root mean square deviation from flatness of the substrate layer over any region 1 mm×1 mm square is less than 140 nm for UVC design wavelengths and less than 400 nm for NIR design wavelengths.

More preferably the root mean square deviation from flatness of the substrate layer over any region 1 mm×1 mm square is less than 70 nm for UVC design wavelengths and less than 200 nm for NIR design wavelengths.

The term “surface covering” herein refers to a film including at least a substrate layer and at least two different dielectric layers. The surface covering may also optionally include metallic layers, pigment layers, a thermal insulation layer, a protective coating layer, an attachment means, a radiation emitter means and a sensor means.

In one embodiment the surface covering is formed into tiles where the tiles may have substantially identical spatial extends or a plurality of different spatial extents. The tiles may be arranged to form a decorative pattern.

In one embodiment the surface covering forms an interior surface of a room selected from the list of a window, a wall, a floor or a ceiling.

In one embodiment the surface covering forms at least one surface of an item of furniture or an item of equipment.

In one embodiment, the surface covering forms at least one surface of an appliance. The appliance may for example be mobile, being transported into a room or chamber as required. The appliance may for example be hung on a wall.

In one embodiment the surface covering further includes an aperture and radiation with wavelengths between 250 nm and 280 nm is transmitted through the aperture.

In one embodiment the surface covering further includes an aperture and radiation with wavelengths between 700 nm and 2000 nm is transmitted through the aperture.

In one embodiment the surface covering further includes an integral light emitting device where the light emitting device emits radiation with at least one wavelength between 250 nm and 280 nm or the light emitting device emits radiation with at least one wavelength between 400 nm and 700 nm or the light emitting device emits radiation with at least one wavelength between 700 nm and 2000 nm.

In one embodiment the surface covering further includes at least one integral radiation sensor operable to measure the intensity of radiation at wavelengths between 250 nm and 280 nm or at wavelengths between 700 nm and 2000 nm.

In one embodiment the substrate layer further includes a fixture for attachment to a frame.

In one embodiment the substrate layer further includes an adhesive layer on the back surface.

In one embodiment the surface covering forms at least one internal surface of a hospital, medical facility, nursing home, residence, commercial space, or manufacturing space.

### BRIEF DESCRIPTION OF THE DRAWINGS

Embodiments of the invention will now be described in conjunction with the accompanying drawings in which:

FIG. 1A shows a cross sectional view of a short segment of one embodiment of a reflective chamber lining of the invention, where the reflective lining can be used in many locations including but not limited to those shown and described in the above identified patent applications.

FIG. 1B is a cross-sectional view of an embodiment similar to FIG. 1A except that substrate layer 10 is immediately overlain by pigment layer 15A which can function to absorb, scatter and reflect radiation with wavelengths in the visible region between approximately 400 nm and 700 nm.

FIG. 1C is a cross-section of an embodiment similar to FIG. 1B except that substrate 10 is immediately overlain by an attachment layer 16 and pigment layer 15B underlies substrate layer 10.

FIG. 2A schematically shows a microscopic cross section of substrate generally indicated at 20.

FIG. 2B shows an image of a nominally flat and reflective aluminum surface viewed through a microscope.

FIG. 2C shows an image of a microscopically flat and reflective aluminum surface viewed through a microscope.

FIG. 3 shows a graph of the theoretical reflectivity of the arrangement of FIG. 1A as a function of angle wherein the substrate layer 10 is aluminum polished to RMS deviation less than 67 nm.

FIG. 4 shows a graph of reflectance curves for a quartz substrate layer 10 in the arrangement of FIG. 1A and a copper pigment layer 15A in the arrangement of FIG. 1B.

FIG. 5 schematically indicates the full range of curvature parameters that may be used with in optical cavities described in the above cited MPS patent.

FIG. 6A illustrates a method for applying the reflective liner of the above embodiments to a cylindrical duct.

FIG. 7 schematically illustrates a method for the construction of an optical surface using flat tiles of different sizes.

FIG. 8 schematically shows a further embodiment comprising room sized reaction chamber.

FIG. 9A schematically illustrates a further embodiment comprising a thermal radiator within a duct volume bounded by duct walls.

FIG. 9B illustrates the amplitude of UV radiation within and proximate to the vanes of the thermal radiator in a duct of FIG. 9A.

### DETAILED DESCRIPTION

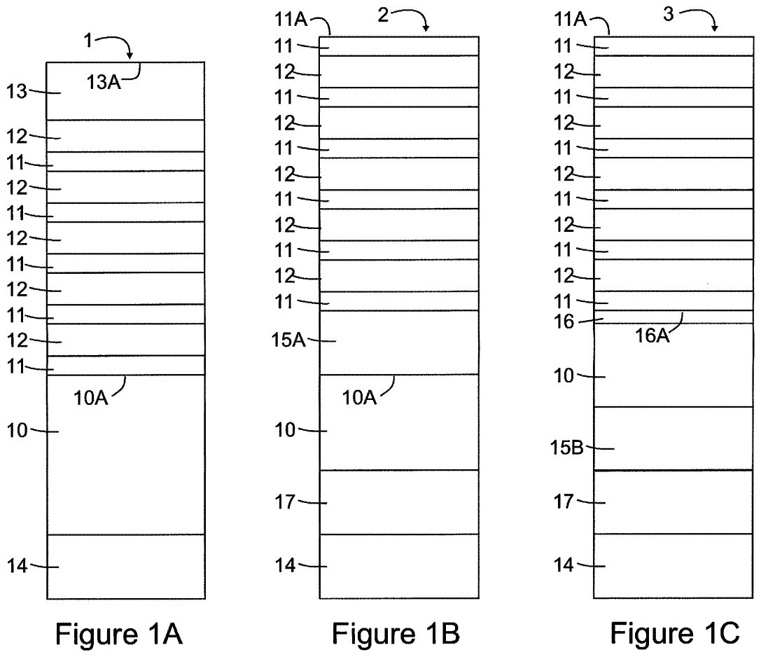

FIG. 1A shows a cross sectional view of a short segment of one embodiment of a reflective chamber lining of the invention indicated at 1. The drawing illustrates the layer structure and is not to scale. Only a short segment is illustrated with radius of curvature large compared with the scale of the layer structure. The substrate layer 10 is typically on the order of tens to hundreds of microns thick and the dielectric layers are typically tens of nanometers thick. The overall thickness of the chamber lining is typically less than one millimeter, but may in some instances be more than 10 mm thick for applications that require structural strength in addition to the optical properties described herein. The chamber lining is preferably flexible with a radius of curvature at least 10 times the liner thickness and more preferably at least 100 times the liner thickness. Flexibility and the ability to conform to a structural surface is an important optional feature of the invention. However in some applications the liner is placed on a flat surface and there is no requirement for flexibility: that is the radius of curvature may be very large or even infinite. The reflective chamber lining consists of substrate layer 10 with smooth surface 10A. Smooth surface 10A has RMS deviation from a mean surface profile of less than one quarter wavelength of incident radiation and preferably RMS deviation from the mean surface profile of less than one twentieth wavelength of incident radiation. Substrate 10 may for example be float glass formed by floating molten glass on the smooth surface of molten tin. Other substrate materials may be formed by analogous methods. Substrate 10 may for example be a polymer film formed by casting onto a smooth surface such as a silicone mould. Substrate 10 may be formed for example by extrusion wherein surface tension is sufficient to minimize surface area to ensure smoothness. Substrate 10 may be formed by polishing a material to the required RMS smoothness of less than a quarter of an incident radiation wavelength. Substrate 10 is overlain with alternating layers of high refractive index material 11 and low refractive index material 12 that are formed parallel to the substrate 10 with the same smoothness standard. The optical path length (thickness×refractive index) of each layer 11 or 12 is substantially one quarter of the wavelength of incident radiation, preferably within 5% of the quarter wavelength optical thickness. Materials for layers 11 and 12 are selected to be substantially transparent to radiation at the incident wavelength. Materials for layers 11 and 12 are preferably selected to maximize the difference between their respective refractive indexes. ZrO2 and HfO2 are acceptable choices for the high refractive index material of layers 11. SiO2 is an acceptable choice for the low refractive index material of layers 12. Other choices of material may be made. Different layers of type 11 may be comprised of different materials provided that the refractive index of the selected material is higher than the refractive index of adjacent layers of type 12. Different layers of type 12 may be comprised of different materials provided that the refractive index of the selected material is lower than the refractive index of adjacent layers of type 11. While 5 layers each of 11 and 12 are shown for illustrative purposes, the number of layers of each type may range from 1 to more than 10. The alternating layers 11 and 12 collectively produce constructive interference at the incident wavelength to form a dielectric mirror with reflectivity at that wavelength typically over 99% and possibly more than 99.9%. Preferably, but not necessarily, the outermost layer of the dielectric stack is comprised of the higher refractive index material used for layers 11. In the example shown in FIG. 1A, the outermost layer is a layer of type 12 immediately overlain by a layer of protective material 13. Protective material 13 is transparent to radiation at the selected wavelength and the thickness is selected to provide mechanical protection to the underlying dielectric mirror layers 11 and 12. The material used for protective layer 13 may for example be the same as the material used for layers of type 11, the only difference being the thickness selected. Incident radiation at the selected wavelength enters through the top surface of reflective liner 1 through surface 13A of layer 13, is transmitted through layer 13 and is almost entirely reflected by alternating layers of high and low refractive index material 11 and 12, respectively. The overall reflectivity may be affected by the choice of the substrate material. For example, if the substrate material is quartz the reflectivity for 8 alternating dielectric layers is 84% whereas if the substrate material is aluminum the reflectivity for the same stack of alternating dielectric layers is more than 99.5%. Substrate layer 10 is underlain by attachment layer 14 which functions to attach reflective liner to a structure. Attachment layer 14 is unique from the other layers in that the attachment layer does not necessarily extend over the entire spatial extent of the reflective liner. That is the attachment layer may be present at one or more discrete locations and not at other locations. Attachment layer 14 may for example be an adhesive layer. Attachment layer 14 may for example be a polymer or metal thick enough to accept a fastener such as a screw. In some cases the attachment layer 14 and substrate layer 10 may be of the same material distinguished only by the functionality of the material region (substrate or attachment).

The reflective film of the present invention may be used in applications discussed in the above cited MPS patent by the current inventors together with example applications enumerated below.

Example 1: A reflective dielectric film with a design wavelength of approximately 260 nm may be applied using an adhesive layer to the inner surfaces (usually steel) of a HVAC duct. Preferably the HVAC duct is shaped with curved surfaces to optically amplify the UV radiation intensity as discussed in the above cited MPS patent. The reflective film may be cut to conform to the shape of each surface prior to application. The reflective dielectric film may include a pigment layer that displays at visible wavelengths technical specifications, alignment marks and the like. In some cases, the reflective film is attached to tiles and the tiles are assembled (with a supporting frame) in three dimensions to produce for example a parabolic UV mirror. UV radiation at the design wavelength (260 nm) may be introduced to the HVAC duct (i) by a UV radiation source in the interior of the HVAC duct, (ii) by UV LED radiation sources integral to the reflective film as described above, (iii) through apertures in the reflective film. Preferably the aperture in case (iii) is in communication with an arrangement for focusing UV radiation from a discharge tube through an aperture as described in the above cited MPS2 patent by the current inventors.

Example 2: A reflective dielectric film with a design wavelength of approximately 1000 nm may be applied using an adhesive layer to the inner surfaces (usually steel) of a HVAC duct. Preferably the reflective dielectric film includes a thermal insulation layer. Optionally a pigment layer is included in the reflective dielectric film that displays technical information and alignment marks. The reflective dielectric film functions to retain heat in the duct by reducing both radiative and conductive losses. In a related application, reflective dielectric film with a NIR design wavelength may be made to conform to the shape of a reflector for a heat lamp. In some cases, the reflective dielectric film is attached to tiles and the tiles are arranged to form the reflector for a heat lamp. Thermal radiation from a heat lamp may be collected and directed in a particular direction using methods described in the above cited MPS2 patent by the current inventors. In a further related application, dielectric reflective film with a NIR design wavelength may be applied to the inner surface of a winter garment to reduce the rate of radiative heat loss. The garment material provides the thermal insulation layer in this case. Alternately, the reflective dielectric film with a NIR design wavelength may be applied to the exterior surfaces of a high temperature protection garment to reduce radiative heating. The reflective dielectric film may for example be shaped as overlapping scales as described in the above cited MPS patent by the current inventors. The scales may be overlay (or replace) aluminized fabric currently used for high temperature protection garments. The NIR design wavelength is selected to match the black body emission peak for the temperature the garment is anticipated to be exposed to. The high temperature protection garment may be used for example by fire fighters, foundry workers, military, and others who may be exposed to high temperatures.

Example 3: The inner surfaces of a photochemistry reaction chamber as described in the above cited MPS patent by the current inventors is lined with a reflective film with a design wavelength of 300 nm. The reflective film may be cut into shapes that conform to the shape of the reaction chamber surfaces and attached with adhesive. The photochemistry reaction chamber may be closed during the reaction, which may give optical amplification of more than 100 if every interior surface is lined with the reflective film. The reflective film may include two types of integral UV radiation sources emitting at 280 nm and 320 nm to photo-catalyze different stages of a chemical reaction. The reflective film may be in communication with a control means that activates and de-activates the UV sources to give a controlled dose of radiation for each wavelength.

Example 4: A reflective dielectric film with a design wavelength of approximately 260 nm may be applied using an adhesive layer to the inner surfaces of a bio-safety cabinet. The reflective film preferably has integral UV sources so that there are no apertures for biohazards to escape through. Preferably, the reflective film includes the electrostatic feature described above for the purpose of preventing contamination by trapping particles from air in the cabinet on the cabinet walls. Preferably the reflective film includes an integral sensor as described above to measure the intensity of UV radiation in the cabinet. Biological samples stored in the bio-safety cabinet may be kept in containers that are opaque to UV radiation. The high reflectivity of the reflective dielectric film enables the bio-safety cabinet and external surfaces of sample containers to sterilized quickly with a high dose of UV radiation. The reflective film may be in communication with a control means that activates and de-activates the UV sources and electrostatic elements.

Example 5: A reflective dielectric film with a design wavelength of 1000 nm may be applied using fasteners to the inner surface of an oven to reflect infrared radiation into the oven, thereby reducing the energy consumption and improving the homogeneity of thermal energy in the oven. Preferably the reflective dielectric film includes the thermal insulation feature described above to reduce conduction losses. Optionally, the reflective dielectric film may include integral resistive electrical traces that generate heat with the flow of electric current. Optionally, the reflective dielectric film may include integral sensors that are used to measure the oven temperature. In some embodiments, the reflective dielectric film is attached to tiles that may be assembled into a three dimensional chamber for operation and disassembled into tiles for transport. Ovens of different sizes may be constructed using different numbers of standard tiles for example to cure composite assemblies of different sizes. The oven may be an autoclave. The oven may be used for sterilization by heat. An oven constructed with dielectric film tiles may be used for food preparation in remote locations where the high energy efficiency and portability are most advantageous. The reflective film may be in communication with a control means that activates and de-activates the heat sources in response to signals from integral sensors.

Example 6: A reflective dielectric film with a design wavelength of 1000 nm may be applied using adhesive to the outer surface of a refrigerator or cryogenic container to reflect infrared radiation, thereby reducing the power required to maintain a sub-ambient temperature. Preferably the reflective dielectric film includes the thermal insulation feature described above to reduce conduction losses. Preferably the reflective dielectric film includes pigment regions that produce a decorative pattern at visible wavelengths. A second reflective dielectric film with a design wavelength of 260 nm may be applied to the inner surface of the refrigerator. The second dielectric film may include integral UV radiation sources. Optionally, the second reflective dielectric film may include integral sensors that are used to measure the refrigerator temperature. The second reflective film may be in communication with a control means that activates and de-activates UV sources to provide a measured sterilizing dose when the refrigerator or cryogenic chamber is closed. The UV dose may for example reduce food spoilage and cross contamination. The UV dose may for example sterilize the interior of a cryogenic container holding pathogen samples.

Example 7: A reflective dielectric film with a design wavelength of 1100 nm may be applied to the walls, ceiling, and floor of a room in a residential building. The reflective dielectric film preferably includes a thermal insulation layer. The reflective dielectric film preferably includes the electrostatic feature described above to capture allergen particles from the room air. The reflective dielectric film preferably includes a plurality of pigment regions that produce a decorative pattern at visible wavelengths. The decorative pattern may include regions that take the function of a sign at visible wavelengths while retaining high reflectivity at the NIR design wavelength. The decorative pattern may for example convey information such as a room number, a washroom location, or a fire exit. The reflective dielectric film may optionally include a plurality of integral visible light sources that may provide diffuse illumination at visible wavelengths. The reflective dielectric film may optionally include sensors linked to a control means that detects the presence of a human in the room activates the visible light sources when a human is present.

Example 8: A reflective dielectric film with a design wavelength of 260 nm may be applied to the walls, ceiling, and floor of a room in a hospital, nursing home or similar medical facility. Preferably the reflective dielectric film is attached to tiles that cover the interior surfaces of the room (walls, ceiling and floor). In case of damage to a tile, only a single tile need be replaced. Preferably the reflective dielectric film includes a coating layer that protects the dielectric stack and enables the film to be cleaned regularly. Preferably the reflective dielectric film includes integral radiation sources emitting 260 nm radiation. Preferably the reflective dielectric film includes a plurality of different pigment regions that produce a decorative pattern at visible wavelengths. As noted above, parts of the decorative pattern may convey useful information. For example, a floor tile may include symbols indicating a path direction. Alternately, each tile covered with reflective dielectric film has a single pigment type and tiles with different pigment types are arranged to produce a decorative mosaic pattern. Preferably the reflective dielectric film includes the electrostatic feature to remove potentially infectious particles from circulation. The reflective dielectric film preferably includes a sensor to measure the intensity of UVC radiation. The reflective dielectric film may optionally include an insulation layer. The reflective dielectric film may be in communication with a control means that activates the integral UV radiation sources to sterilize the room between uses (when no humans are present) and de-activates the integral UV radiation sources when humans are present. Alternately, the reflective dielectric film may include apertures that admit UV radiation for sterilization. The sterilizing radiation may be from the arrangements given in the above cited MPS2 patent by the current inventors. The sterilizing radiation may be from a 222 nm source in which case the design wavelength of the reflective dielectric film is set to 222 nm. As UV radiation with a 222 nm wavelength does not penetrate human skin the 222 nm source may be active when humans are present.

FIG. 1B is similar to FIG. 1A except that substrate layer 10 is immediately overlain by pigment layer 15A which functions to absorb, scatter and reflect radiation with wavelengths in the visible region between approximately 400 nm and 700 nm. Substrate layer 10 is underlain by thermal insulation layer 17 which functions to reduce thermal conductivity between top surface 11A and attachment layer 14. The dielectric layers 11 and 12 function to specularly reflect radiation at a selected wavelength or range of wavelengths and to transmit at least some visible wavelengths to the pigment layer 15A with a first intensity distribution with respect to wavelength. The pigment layer 15A modifies the first intensity distribution and reflects a second intensity distribution at visible wavelengths back through the dielectric layers 11 and 12 to an external viewer. That is the reflective liner functions as a high reflectance mirror at a selected wavelength and as colored surface at visible wavelengths. The composition of the pigment layer 15A may vary spatially so as to form a decorative pattern or image. The numeric labels in FIG. 1B have the same meaning as the numeric labels in FIG. 1A with the same numeric values.

FIG. 1C is similar to FIG. 1B except that substrate 10 is immediately overlain by an attachment layer 16 and pigment layer 15B underlies substrate layer 10. A thermal insulation layer 17 optionally underlies pigment layer 15B. In this arrangement, substrate layer 10 and attachment layer 16 are transparent for at least some wavelengths in the visible region between 400 nm and 700 nm. Pigment layer 15B functions in the same way as pigment layer 15A described above, except that incident and reflected wavelengths additionally transverse substrate 10 and attachment layer 16. Attachment layer 16 may serve two functions. Firstly, the material of attachment layer 16 is selected to adhere well to the material of substrate material 10 and dielectric layer 11 or 12. For example, if the material of the immediately overlying dielectric layer (11 or 12) does not adhere well to the material of substrate 10, attachment layer 16 is included to bridge between substrate 10 and the dielectric layer. Secondly, attachment layer 16 may function to provide a smooth surface 16A for overlying dielectric layers. Attachment layer 16 may for example be deposited as a low viscosity phase or material that fills in gaps and void in the irregular surface of substrate 10 and presents a smooth surface to dielectric over layers. Attachment layer may for example be a low viscosity polymer that is spin cast on the substrate surface and then set by cooling or cross linking in with a smooth surface conformation. Attachment layer 16 may be more economical to add than fine polishing of substrate 10. The numeric labels in FIG. 1C have the same meaning as the numeric labels in FIG. 1B with the same numeric values.

The layered arrangements shown in FIGS. 1A, 1B, and 1C are illustrative only. The features described may be used (or not used) in any combination within the scope of the invention.

The layered arrangements shown in FIGS. 1A, 1B, and 1C may be fabricated by processes including vacuum evaporation, sputtering, and chemical vapor deposition as well as wet chemical processes such as electroplating and layer by layer deposition. The fabrication process is preferably quasi-continuous such as a roll-to-roll vacuum sputtering process.

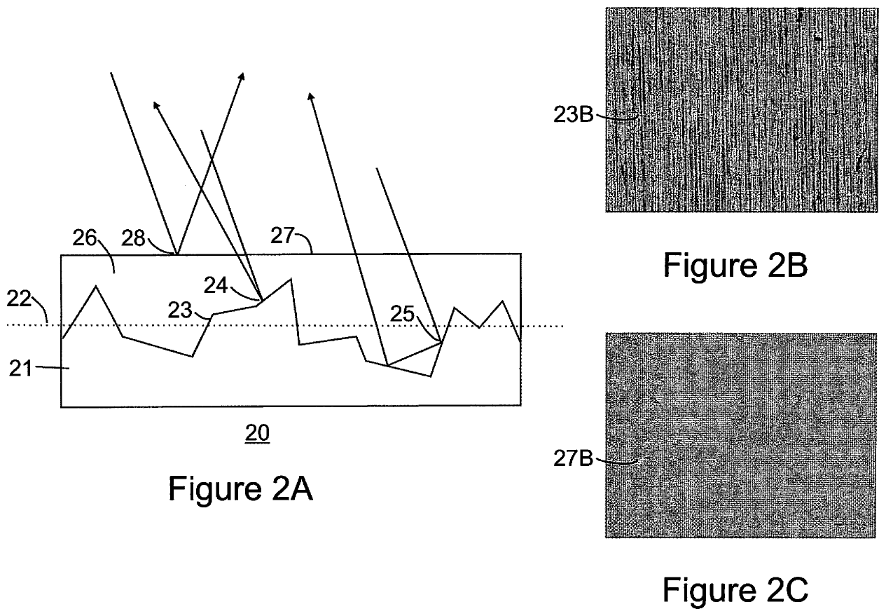

FIG. 2A schematically shows a microscopic cross section of substrate generally indicated at 20. Substrate 21 has mean surface 22 and microscopically rough surface profile 23. FIG. 2B shows an image of a nominally flat and reflective aluminum surface viewed through a microscope. The image 2B shows ridges and valleys with a length scale of approximately 20 microns as indicated at 23B. The aluminum shown in FIG. 2B does not meet the surface smoothness required (65 nm assuming 260 nm radiation is incident). Radiation incident on surface 23 may be reflected at non-specular angles with respect to mean surface 22 as shown at 24. Radiation incident on surface 23 may be multiply reflected at non-specular angles with respect to mean surface 22. The non-specular reflection shown at 23 and 24 greatly diminishes the effectiveness of the mean surface 22 to direct radiation in a particular direction. That is the mean surfaces shown in prior art are ineffective without the degree of smoothness described in the present disclosure. As discussed above, an attachment layer indicated at 26 may be added to provide a smooth surface 27 with specular reflection as indicated at 28. Alternately, surface 23 may be polished to the required quarter wavelength smoothness as shown at 27B in FIG. 2C.

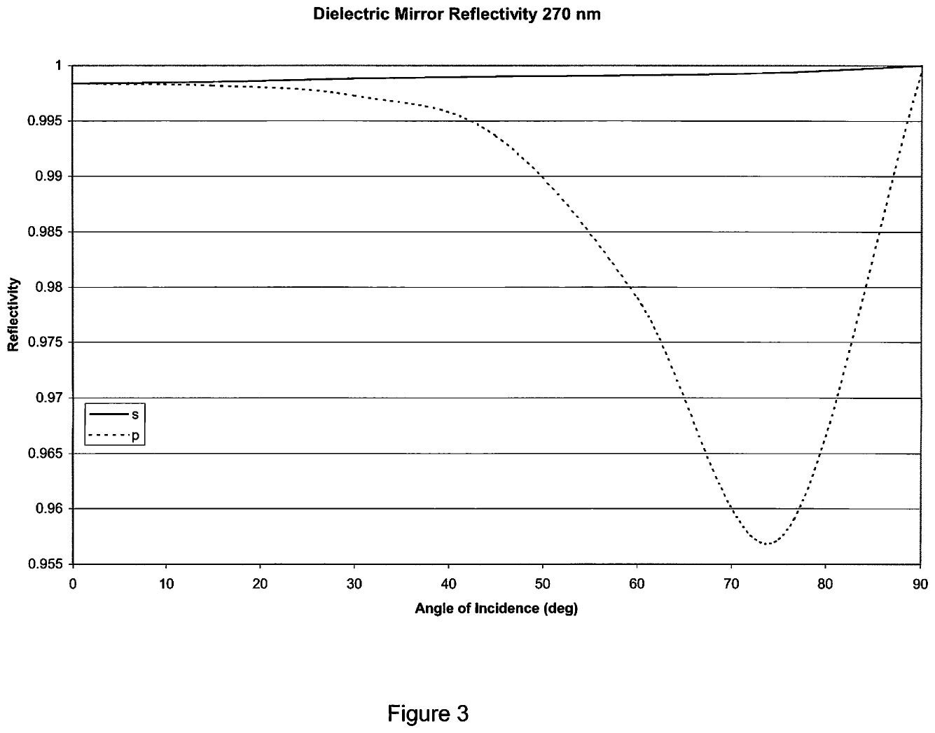

FIG. 3 shows the theoretical reflectivity of the arrangement of FIG. 1A as a function of angle wherein the substrate layer 10 is aluminum polished to RMS deviation less than 67 nm. The reflectivity for s-polarized radiation at 270 nm is more than 99.8% for all angles of incidence. The reflectivity of p-polarized radiation decreases with angle of incidence to a minimum of 95.7% near 74 degrees. As the average angles of incidence are known and controlled at each location in the above cited MPS patent, the dielectric layer thicknesses may be varied by location such that the reflectivity is maximized for the average angle of incidence at each location and the minimum reflectivity is at an infrequent angle of incidence. That is the stack of layers has a first area arranged with selected thicknesses of the layers such that the incident ray of light is reflected by the stack if the angle of incidence of the ray falls within a first predetermined range of angles and is transmitted through the stack if the angle of incidence of the ray falls in a different predetermined range of angles and the stack has a second area arranged with selected thicknesses of the layers such that the incident ray of light is reflected by the stack if the angle of incidence of the ray falls within a second predetermined range of angles different from the first predetermined range of angles and is transmitted through the stack if the angle of incidence of the ray falls in a different predetermined range of angles.

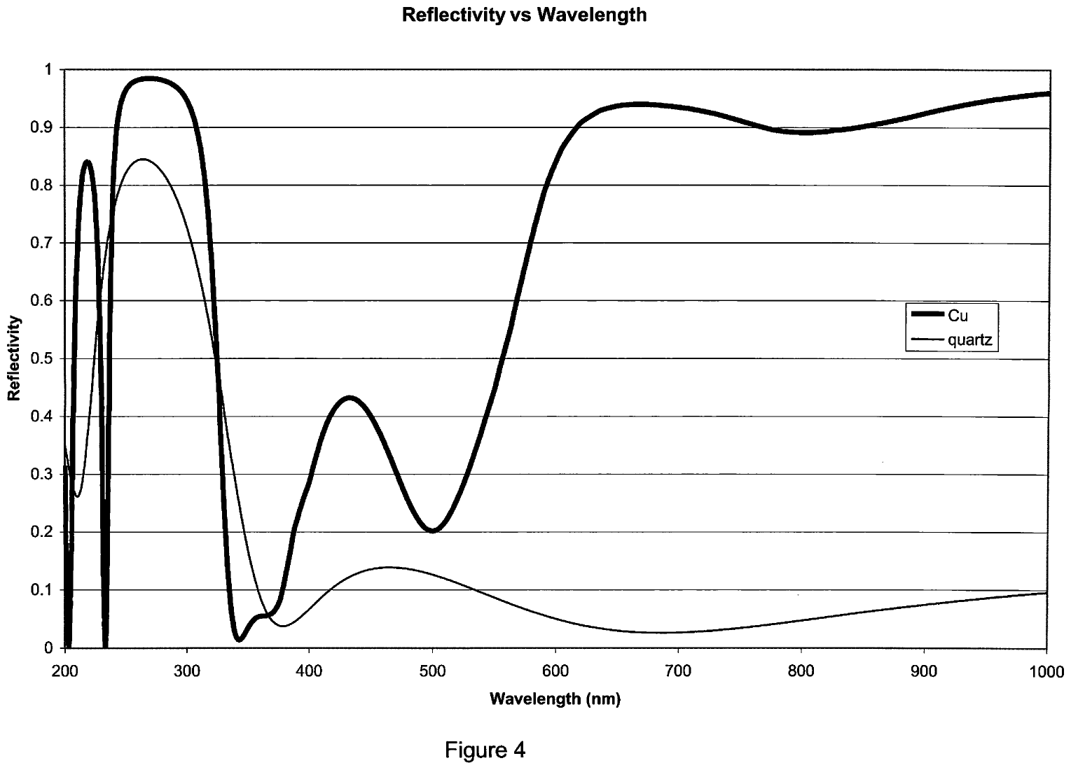

FIG. 4 shows reflectance curves for a quartz substrate layer 10 in the arrangement of FIG. 1A and a copper pigment layer 15A in the arrangement of FIG. 1B. The quartz curve illustrates high reflectivity (84%) at UV wavelengths near 270 nm and near transparency at visible wavelengths between 400 nm and 700 nm. The arrangement of FIG. 1A can hence be used as a dichroic mirror with reflectivity in the UV and transparency at visible wavelengths. The dichroic mirror with the added feature of attachment layer 14 may be attached to a transparent structural material and used as a window for a reaction chamber. The window may be used to observe Raman scattered UV radiation as described in the above cited MPS patent. The window may be integral to a room sized reaction chamber and used to confirm that no humans are present prior to activating a UV source within the chamber.

The copper pigment layer plot shows that a UV mirror with a reddish appearance at visible wavelengths can be fabricated. By choosing different pigment layer compositions, the visual appearance of the UV mirror can be modified.

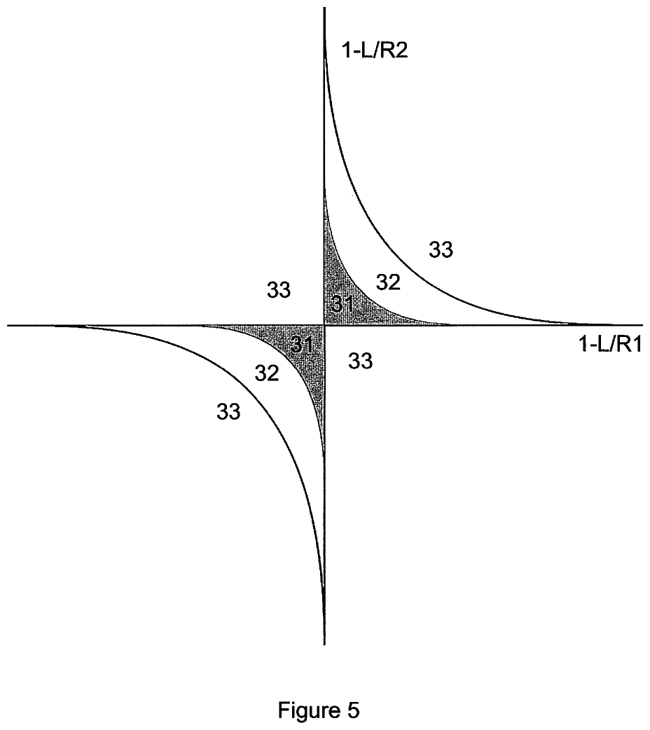

FIG. 5 schematically indicates the full range of curvature parameters that may be used with in optical cavities described in the above cited MPS patent. In the MPS patent optical cavities are formed with opposing reflective surfaces that may be simple (two surfaces) or compound (with one or more folding mirrors intermediate between end mirrors. In FIG. 5 the axes relate the distance between end reflectors L to the radius of curvature of the end mirrors R1 and R2. The regions labeled 31 correspond to theoretically stable regions in which rays will bounce between end mirrors of perfect reflectivity an infinite number of times. In practice the reflectivity is less than 1 and the amplitude of reflected light decays exponentially. For highly reflective surfaces of the type described in the present disclosure, the reflectivity can be measured by measuring the rate of exponential decay for an optical cavity in region 31. This theoretical region is described by the inequality;

$$0 <= ( 1 - L / R 1 ) * ( 1 - L / R 2 ) <= 1$$

Reaction chambers constructed within region 31 are assured to perform well due to their inherent stability. The most preferred configuration within region 31 is the confocal configuration which gives good separation between end mirrors and is simple to construct. The inclusion of side walls creates a zone of quasi stability indicated by regions 32 where reaction chamber performance may be as good or better than the performance of theoretically optimal region 31. Conceptually, this is a region in which most of the reflections are between end mirrors with very high reflectivity and a small fraction of reflections involve less reflective side walls. Because the overall performance of a reaction chamber depends on the average path length between reflections where at least some energy is lost, some configurations within region 32 that increase the path length between reflections may provide better overall performance than configurations within region 31. Region 32 is described by the inequality:

$$0 <= ( 1 - L / R 1 ) * ( 1 - L / R 2 ) <= q$$

where q is preferably less than 4. More preferably q is less than 2.

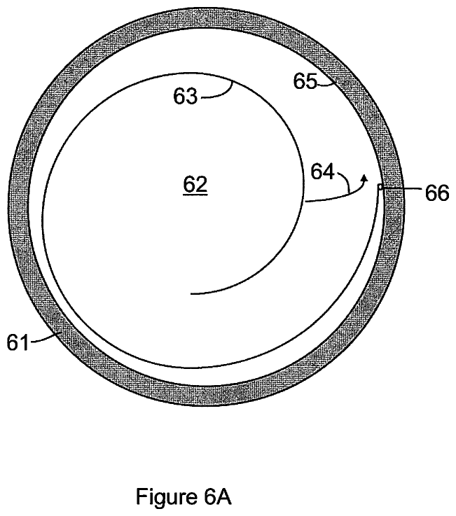

FIG. 6A illustrates a method for applying the reflective liner to a cylindrical duct. The reflective liner 63 is loosely coiled to a radius of curvature less than the radius of curvature of cylindrical duct 61 and placed into the interior space 62 of the duct such that a small adhesive region makes contact with the duct inner surface 65. The reflective liner 63 then elastically expands as indicated at 64 to conform to the curvature of the duct inner surface 65. The elastic force resists radial distortion of the reflective liner 63 and the adhesive resists movement along the cylinder axis. In an alternate arrangement, the reflective liner may be applied to a pre-formed shape such as a two dimensional parabola fabricated for example by a moulding or stamping process. In this case the adhesive layer preferably covers the entire back surface of the reflective liner. The method may be applied with slight modification to ducts with rectangular cross section by folding the reflective liner into a rectangular spring. The arrangement shown in FIG. 6A is especially useful for applying the reflective liner to HVAC ducts to improve the effectiveness of UV sterilization within the duct.

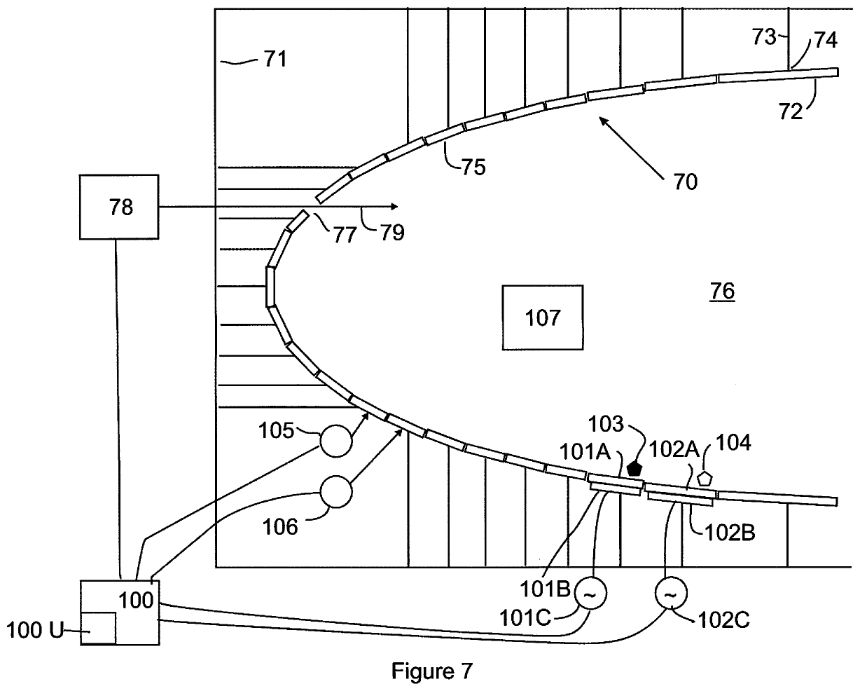

FIG. 7 schematically illustrates the construction of an optical surface generally indicated at 70 using flat tiles of different sizes 72 and 75. The optical surface may for example form the inner surface (or portion thereof) of a reaction chamber 76 as discussed in the above cited MPS patent. The flat tiles are the arrangement of FIG. 1B wherein the substrate 10 is an optical glass polished to better than quarter wavelength RMS smoothness. The pigment layer 15A may be aluminum, which enhances the UV reflectivity of the dielectric layers as discussed in the above cited MPS patent. The flat tiles are connected to a lattice frame schematically shown at 71 by spars 73 which interface with attachment regions 74 of the reflective tiles. The reflective tiles may be produced in a plurality of standard sizes and shapes which may be used to assemble optical components of any three dimensional form. The lattice frame may include a gap between tiles 77 that functions as an aperture allowing UV radiation 79 to pass into reaction chamber 76 from UV source 78. UV source may for example be a LED in communication with control means 100. Control means may for example be a CPU, a FPGA, an analog circuit, or other suitable circuit operable to switch UV source between on and off states. Control 100 may include a user interface 100U which provides information about the state of each device control 100 is in communication with and allows a user to change the state of each device control 100 is in communication with. Control means 100 may be in communication with an indicator light 105 that is on when UV source 78 is on and off when UV source 78 is off. Alternately, the indication state may be reversed. In some embodiments, indicator light 105 is integral with a tile and transmits temporally modulated radiation at selected wavelengths into chamber 76 which are received by computation device 107. Computation device 107 may process the temporally modulated radiation at selected wavelengths to extract information from the modulation pattern. Computation device 107 may emit temporally modulated radiation at selected wavelengths that is received by sensor 106 integral with a tile and in communication with control means 100. Control means 100 may process the temporally modulated radiation at selected wavelengths to extract information from the modulation pattern. Preferably UV source 78 is the arrangement described in the above cited MPS2 patent which directs a collimated beam from an extended UV radiator such as a gas discharge tube through a smaller aperture. As discussed in more detail in the above cited MPS and MPS2 patents, injecting collimated UV radiation into chamber 76 through an aperture reduces optical losses and collimation increases the optical amplification of the chamber shape as discussed in FIG. 5 above. Because the tiles are flat, they are easier to polish to the required smoothness giving a reduction in cost relative to polishing a three dimensional form to the same RMS smoothness. Numerical simulations show that parabolic shapes made according to the arrangement shown in FIG. 7 produces the same overall radiation intensity in a chamber to within 2%. Control 100 may be in communication with voltage sources 101C and 102C connected with conductive pads 101B and 102B, respectively. Conductive pads 101B and 102B are shown enlarged on the rear surfaces of reflective films 101A and 102A, respectively. Control 100 generates signals that cause conductive pads 101B and 102B to be held at different voltages, for example above and below the ground voltage of the frame 71. The electric field generated attracts differently charged particles 103 and 104 to surfaces 101A and 102A, respectively.

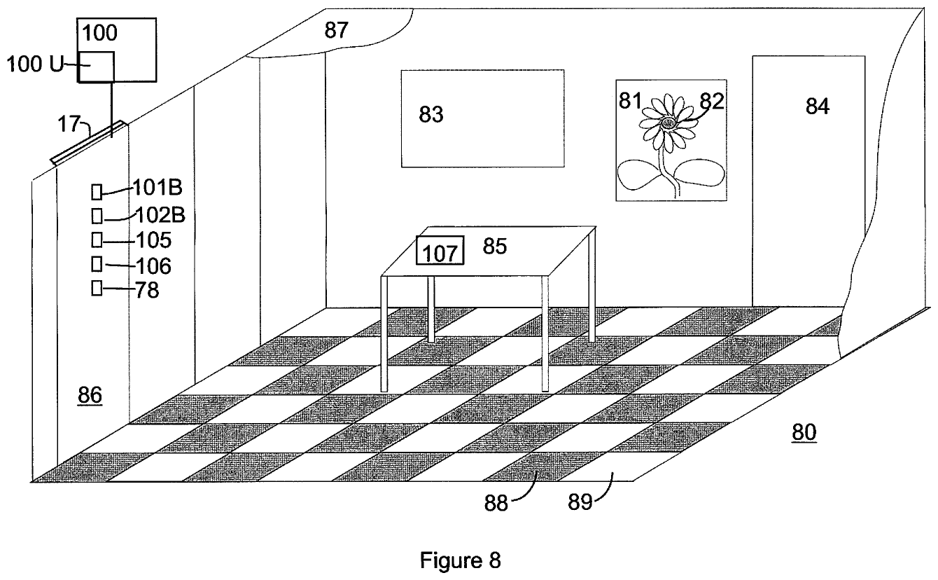

FIG. 8 schematically shows a room sized reaction chamber generally indicated at 80. The room sized reaction chamber may for example be a room in a hospital that needs to be sterilized between uses. The room sized reaction chamber may for example a washroom that is sterilized between uses. The room reaction chamber may for example be a food processing facility that requires daily sterilization. The interior surfaces of the room reaction chamber may be lined with the reflective liner of the present invention in various forms. The room may include dichroic UV mirror tiles indicated at 81, for example with a quartz substrate as discussed above. The dichroic UV mirror permits a decorative pattern 82 to be viewed at visible wavelengths while being highly reflective at germicidal wavelengths. A dichroic UV mirror may also be used as a window 83 which permits human observation of the room status, such as occupancy. The window 83 may also be on an external wall permitting the room inhabitant a view of nature outside the building when the window is not being used as a UV reflector. The reflective liner may cover the surface of a door which permits access to the room reaction chamber. The room may contain furniture 85 that is covered with the reflective liner of the invention. The liner may include pigment layers 15A or 15B that give the furniture item the visual appearance of standard furniture. The walls of the room reaction chamber may be lined with panels 86 covered with the reflective liner in standard sizes. The wall panels 86 may include integral UV radiation sources 78 and integral UV detectors 106 as discussed in the above cited MPS patent. The wall panels 86 may include conductive regions 101B and 102B held at different voltages for the purpose of attracting particles from air in the reaction room 80. The wall panels 86 may include integral radiation source 105 that may transmit temporally modulated radiation at selected wavelengths received by computation device 107. The wall panels 86 may include integral sensor 106 that receives temporally modulated radiation from computation device 107. The temporally modulated radiation signals may be processed by control means 100 and computation device 107 to provide information (typically converted to binary data based on the modulation pattern detected). The wall panels may include a thermal insulation layer 17. The floor may be covered with tiles 88 and 89 with the reflective liner integral to their structure. The tiles 88 and 89 may include different types of pigment layers 15A to provide different visual appearances. Tiles with different appearance 88 and 89 may be assembled into decorative patterns. Preferably the floor tiles include protective layer 13 as shown in FIG. 1A for wear resistance. The floor panels 88 and 89 may include a thermal insulation layer 17. The floor tiles 88 and 89 may include radiation sources 78 and 105 and sensor 106. Likewise, the ceiling may be covered with the reflective liner as indicated at 87. The ceiling tiles 87 may include conductive regions (not shown) held at different voltages for the purpose of attracting particles from air in the reaction room 80. The ceiling tiles may include radiation sources 78 and 105 and sensor 106. The ceiling tiles 87 may include a thermal insulation layer 17.

The room reaction chamber illustrated in FIG. 8 may have average UV reflectivity over all surfaces: floor, walls, ceiling and furniture well in excess of 95%, a substantial improvement on prior art UV reflective paint with reflectivity up to 60% on only some surfaces. The higher UV reflectivity cited reduces the time required to sterilize the room reaction chamber by at least a factor of 8. Faster sterilization gives substantial economic benefits as hospital infrastructure can be used more intensively.

In an alternate arrangement, the room reaction chamber illustrated in FIG. 8 may have average NIR reflectivity over all surfaces: floor, walls, ceiling and furniture well in excess of 95%. Preferably, the floor, wall and ceiling tiles include a thermal insulation layer. The enhanced NIR reflectivity reduces heat loss by radiation and the thermal insulation layer reduces heat loss by conduction.

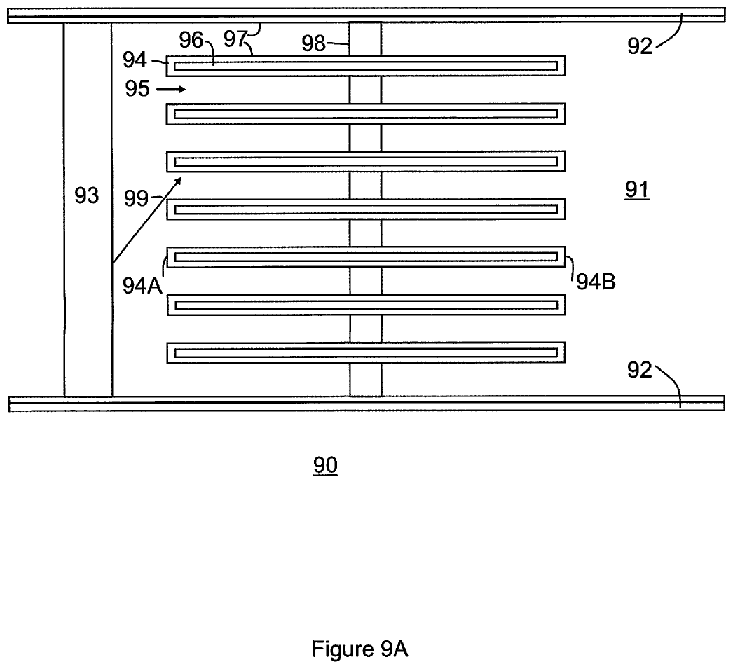

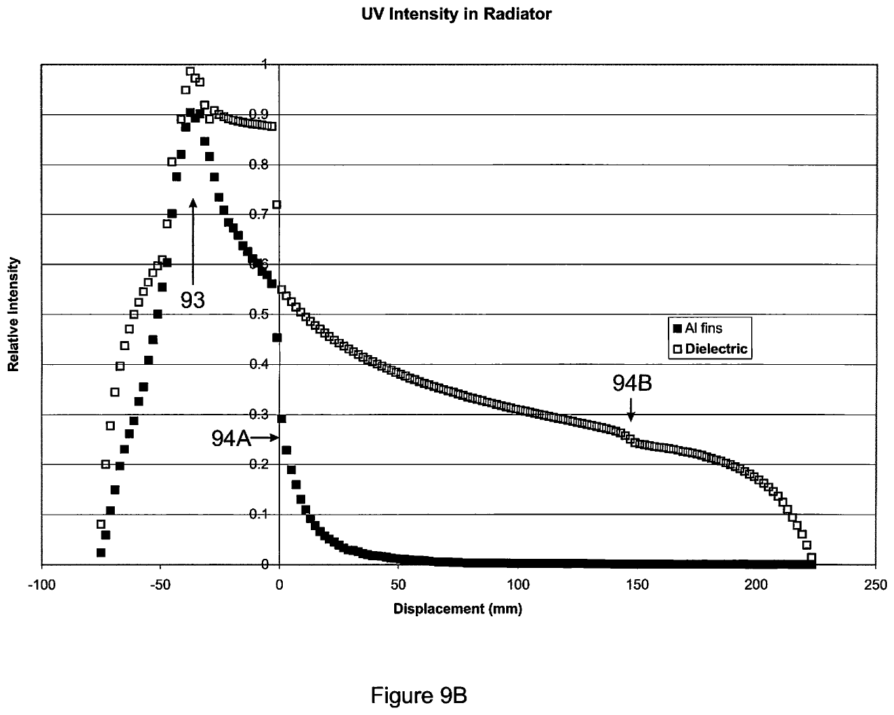

FIG. 9A schematically illustrates a thermal radiator generally indicated at 90 within a duct volume 91 bounded by duct walls 92. The thermal radiator consists of vanes 94 thermally connected with heat pipe 98 that extend across space from 94A to 94B. The surface area of the vanes 94 is operable to transfer heat between heat pipe 98 and air flowing in the gap 95 between the vanes. The vanes 94 consist of a core of thermally conductive material 96 surrounded by a thin layer of UV reflective film 97. The UV reflective film 97 is preferably opaque and non-reflective at NIR wavelengths. The substrate of the UV reflective film may be the thermally conductive layer 96. Alternately the UV reflective layer 97 may be applied as a thin film onto the thermally conductive layer 96. The UV reflective layer may optionally be applied to the duct walls 92. A source of UV radiation 93 within the duct projects rays of UV radiation 99 toward radiator 90. The source of UV radiation 93 may for example be an electric discharge tube. More preferably, the source of UV radiation 93 is a LED.

FIG. 9B illustrates the amplitude of UV radiation within and proximate to the vanes of a thermal radiator in a duct. The model shown is for vanes 1 mm thick with a center to center distance of 4 mm. The solid squares represent the amplitude of UV radiation as a function of displacement from the vane edge 94A nearest radiation source 93 for standard aluminum vanes. As shown, the UV amplitude decreases exponentially to near zero amplitude within 50 mm of the vane edge 94A. The hollow squares represent the amplitude of UV radiation as a function of displacement from the vane edge 94A nearest radiation source 93 for vanes covered with the dielectric film illustrated in FIG. 1A. As shown, the UV amplitude between vanes covered with the dielectric reflective film remains above 25% of the initial value between the edges 94A and 94B 150 mm apart. For an equivalent UV source, the overall integrated UV dose between 94A and 94B is approximately 6800× higher for vanes coated with the dielectric film compared with uncoated vanes. In practice, the UV source used with the dielectric coated vanes may be a LED consuming less power and requiring less maintenance than the gas discharge bulb conventionally used with standard aluminum vanes.

1. A method of forming a surface covering for reflecting UVC radiation comprising:
providing a substrate having a rear surface and a smooth front surface;
wherein the smooth front surface of the substrate is overlain by a stack of substantially parallel dielectric bilayers wherein each bilayer consists of a first dielectric layer and a second dielectric layer arranged substantially parallel to one another and the substrate material; and
wherein the first dielectric layer is comprised of a material that has a higher refractive index than the second dielectric layer.

2. The method according to claim 1 wherein the first dielectric layer is comprised of a material that has a higher refractive index than the second dielectric layer for at least one selected wavelength within the wavelength range from 180 nm to 320 nm; wherein each dielectric layer is substantially transparent at the selected wavelength within the wavelength range from 180 nm to 320 nm and wherein the optical thickness of each dielectric layer is one quarter of a selected wavelength between 180 nm and 320 nm and wherein the bilayers are arranged such that the high refractive index layer of a first bilayer abuts the low refractive index layer of a second bilayer, and wherein the reflectivity of the surface covering at normal incidence is at least 97% and preferably at least 99% for the selected wavelength between 180 nm and 320 nm.

3. The method according to claim 2 wherein the selected wavelength is between 250 nm and 280 nm or between 200 nm and 230 nm.

4. The method according to any preceding claim wherein the first dielectric layer is comprised of a material that has a higher refractive index than the second dielectric layer within the wavelength range from 250 nm to 280 nm; wherein each dielectric layer is substantially transparent at wavelengths between 250 nm and 280 nm and wherein the optical thickness of each dielectric layer is one quarter of a selected wavelength between 250 nm and 280 nm and wherein the bilayers are arranged such that the high refractive index layer of a first bilayer abuts the low refractive index layer of a second bilayer, and wherein the reflectivity of the surface covering at normal incidence is at least 97% and preferably at least 99% for at least one wavelength between 250 nm and 280 nm.

5. The method according to any preceding claim wherein further the stack of substantially parallel bilayers further includes a single outer layer comprised of a material that is substantially transparent at the selected wavelength and has a refractive index at the selected wavelength greater than the refractive index of the abutting bilayer material and the optical thickness of said outer layer is approximately one eighth of the selected wavelength.

6. The method according to any preceding claim wherein the substrate layer is aluminum.

7. The method according to any preceding claim wherein the substrate layer is substantially transparent at wavelengths between 400 nm and 700 nm.

8. The method according to any preceding claim wherein the substrate layer is comprised of glass or quartz or fused silica or glass fibers.

9. The method according to any preceding claim wherein the substrate layer includes a material that absorbs more than 20% of incident radiation for at least one wavelength between 400 nm and 700 nm.

10. The method according to any preceding claim wherein the substrate layer further includes at least two different materials that absorb radiation between 400 nm and 700 nm differently and wherein the at least two different materials are in spatially distinct regions and where the two different materials are optionally of the same thickness.

11. The method according to claim 10 wherein the spatially distinct regions are arranged to form a decorative pattern and wherein each region in the decorative pattern has a different visual appearance.

12. The method according to any preceding claim wherein the root mean square deviation from flatness of the substrate layer over any region 1 mm×1 mm square is less than 140 nm or preferably less than 70 nm.

13. The method according to any preceding claim wherein the surface covering is formed into individual tiles.

14. The method according to claim 13 wherein the tiles have substantially identical spatial extents.

15. The method according to claim 13 wherein the tiles have a plurality of different spatial extents.

16. The method according to claim 13 wherein a plurality of the tiles is arranged to form a decorative pattern.

17. The method according to any preceding claim wherein the substrate with the dielectric bilayers thereon is formed to define at least one interior surface of a room wherein the interior surface is a wall, a floor, or a ceiling.

18. The method according to claim 17 wherein the reflective film is applied to at least one interior surface of a room containing thermal radiation wherein the selected wavelength of the reflective film is one wavelength of thermal (NIR) radiation. Preferably the reflective film includes a thermal insulation layer

19. The method according to any preceding claim wherein the surface covering is formed to define at least one surface of an item of furniture or an item of equipment.

20. The method according to any preceding claim wherein the surface covering is formed to define an aperture and radiation with wavelengths between 180 nm and 320 nm or between 700 nm and 2000 nm is transmitted through the aperture.

21. The method according to any preceding claim wherein the surface covering is formed to define an integral light emitting device.

22. The method according to any preceding claim wherein the surface covering is formed to define at least one integral radiation sensor operable to measure the intensity of radiation.

23. The method according to any preceding claim wherein the surface covering is formed to define a fixture for attachment to a frame.

24. The method according to any preceding claim wherein the surface covering is formed to define an adhesive layer on the rear surface, which may cover all or part of the surface.

25. The method according to any preceding claim wherein the surface covering is formed to define at least one internal or external surface of a hospital, medical facility, nursing home, residence, commercial space, or manufacturing space, garment, oven, refrigerator, or heat reflector.

26. The method according to any preceding claim wherein the front surface of the substrate is fabricated to have a substantially smooth surface to minimize reflection at non-specular angles.

27. The method according to claim 25 wherein the non-specular reflection amounts to less than 10% of the reflected energy and more preferably, the non-specular reflection amounts to less than 1% of the reflected energy.

28. The method according to claim 25 or 26 wherein a metallic layer is placed between the smooth front surface of the substrate and the sequence of dielectric layers.

29. The method according to claim 25, 26 or 27 wherein a pigment layer is placed between the smooth front surface of the substrate and the sequence of dielectric layers selected to produce a desired color effect at wavelengths in the visible region between 400 nm and 700 nm.

30. The method according to any one of claims 26 to 29 wherein the smooth substrate is selected to be transparent or translucent at visible wavelengths between 400 nm and 700 nm.

31. The method according to any preceding claim wherein a metallic layer is placed on the rear surface of the substrate.

32. The method according to any preceding claim wherein the surface covering is formed to define a plurality of different spatial regions and at least two of said spatial regions have one layer of metal or pigment applied and wherein the metal or pigment applied to each spatial region is different where the pattern of pigments applied to different spatial regions of the substrate may generate a decorative pattern.

33. The method according to any preceding claim wherein the surface covering is flexible and can be bent elastically with a radius of curvature at or above a threshold radius of curvature.

34. The method according to claim 33 wherein the surface covering is cut to the length of a duct and a width that corresponds with the circumference of the duct and the width dimension is wound into a coil less than the cylinder radius where the coil is placed in the duct and elastically expands to conform to the duct radius.

35. The method according to any preceding claim wherein the surface covering is rigid and substantially planar: that is the radius of curvature is greater than 10 meters or is applied to or integral with a rigid block to form a planar reflector.

36. The method according to any preceding claim wherein the surface covering is cut into a plurality of sections and the sections are assembled abutting or nearly abutting to form a multi-faceted three dimensional optical surface.

37. The method according to any preceding claim wherein the surface covering is formed to match and is bonded to a three dimensional surface.

38. The method according to any one of claims 1 to 37 wherein a required smoothness of the substrate front surface is prepared by polishing the front surface in a lapping process wherein the substrate is attached to or integral with an optical flat so that the polishing is done relative to an optically flat two dimensional planar surface.

39. The method according to any one of claims 1 to 37 wherein the substrate material is injected into a mold with optically flat surfaces where the substrate material is selected to have low viscosity to conform to the mold surface and a long setting time to minimize dimensional changes upon setting.

40. The method according to any one of claims 1 to 37 wherein the required front surface smoothness is prepared by spin coating a coating material onto a substrate material wherein the coating material adheres to the substrate material and minimizes surface energy so as to produce a smooth surface.

41. The method according to any one of claims 1 to 37 wherein the required smoothness of the substrate front surface may be prepared by an extrusion process wherein surface tension during the extrusion process minimizes the surface area of the substrate and hence produces a smooth surface.

42. The method according to any one of claims 1 to 37 wherein the required smoothness of the substrate front surface is prepared by floating the substrate material on a liquid with a smooth surface.

43. The method according to any preceding claim wherein the substrate material is a polymer and the polymer is selected to resist degradation by UVC radiation at and proximate to the selected wavelength between 180 nm and 320 nm.

44. The method according to any preceding claim wherein the substrate material is a polymer and the front surface of the substrate is overlain with coating that absorbs or reflects UVC radiation between 180 nm and 320 nm such that said radiation incident on the coating layer is not incident on the polymer substrate front surface.

45. The method according to any preceding claim wherein the stack has a first area arranged with selected thicknesses of the layers such that the incident ray of light is reflected by the stack if the angle of incidence of the ray falls within a first predetermined range of angles and is transmitted through the stack if the angle of incidence of the ray falls in a different predetermined range of angles and the stack has a second area arranged with selected thicknesses of the layers such that the incident ray of light is reflected by the stack if the angle of incidence of the ray falls within a second predetermined range of angles different from the first predetermined range of angles and is transmitted through the stack if the angle of incidence of the ray falls in a different predetermined range of angles.

46. A reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the reflective surface covering includes an integral radiation source.

47. The surface covering according to claim 46 wherein the radiation source is a LED that emits at a specific range of wavelengths.

48. The surface covering according to claim 46 or 47 wherein the surface coating is applied to at least one interior chamber surface and wherein the radiation source comprises an electrically resistive conductor that radiates thermal radiation over a broad spectral range and also adds thermal energy to the interior of a chamber via thermal conduction.

49. The surface covering according to any one of claims 46 to 48 wherein a thermal insulation layer is placed on the back surface of the substrate so that the stack functions to reduce radiative energy loss from a chamber interior and the thermal insulation layer functions to reduce conduction of heat energy from the chamber interior.

50. A reflective surface covering applied to a chamber surface for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein a thermal insulation layer is placed on a surface of the substrate so that the stack functions to reduce radiative energy loss and the thermal insulation layer functions to reduce conduction of heat energy.

51. A reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the reflective surface includes decorative features at visible wavelengths that minimally affect the reflectivity of the stack at said selected range of wavelengths.

52. A reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the reflective surface covering is in communication with a control device that functions to activate or inactivate radiation sources, to apply voltages to selected regions of a reflective film or array of reflective films, and/or to receive and process sensor inputs.

53. The surface covering according to claim 52 wherein the sensor inputs are the temperature or the amplitude of radiation at selected wavelengths.

54. The surface covering according to claim 52 or 53 wherein the control device is connected with a communication network and operates to temporally modulate radiation sources at selected wavelengths for the purpose of transmitting data to computation devices proximate to the radiation sources.

55. The surface covering according to any one of claims 52 to 54 wherein the control device is in communication with sensors integral with the reflective film that receive temporally modulated radiation at selected wavelengths from computation devices proximate to the reflective film.

56. The surface covering according to any one of claims 52 to 55 wherein the control device processes said sensor signals to extract data transmitted by the proximate computation device.

57. A reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the stack is underlain by a plurality of separate regions of electrically conductive material wherein each conductive region is in communication with a voltage source via conductive traces and wherein at least two regions are held at different voltages.

58. The surface covering according to claim 57 wherein the electric field produced at the reflective film surface by each conductive region may function to attract and retain particles to the film surface with electrostatic forces, thereby removing said particles from air proximate to the surface and optionally including activation of a UVC radiation source causing ionization.

59. A reflective surface covering for reflecting radiation comprising:
a substrate;
wherein the substrate is overlain by a stack of substantially parallel dielectric bilayers wherein each bilayer comprises a first dielectric layer and a second dielectric layer arranged substantially parallel to one another and the substrate material; and
wherein one of the dielectric layers comprises a material that has a higher refractive index than the other dielectric layer so that the stack forms a reflective layer at a selected range of wavelengths;
wherein the surface covering is formed into individual tiles.

60. The surface covering according to claim 59 wherein the tiles have substantially identical spatial extents.

61. The surface covering according to claim 59 wherein the tiles have a plurality of different spatial extents.

62. The surface covering according to claim 59 wherein a plurality of the tiles is arranged to form a decorative pattern.

63. The surface covering according to any one of claims 46 to 62 wherein the first dielectric layer is comprised of a material that has a higher refractive index than the second dielectric layer within the wavelength range from 180 nm to 320 nm; wherein each dielectric layer is substantially transparent at wavelengths between 180 nm and 320 nm and wherein the optical thickness of each dielectric layer is one quarter of a selected wavelength between 180 nm and 320 nm and wherein the bilayers are arranged such that the high refractive index layer of a first bilayer abuts the low refractive index layer of a second bilayer, and wherein the reflectivity of the surface covering at normal incidence is at least 97% and preferably at least 99% for at least one wavelength between 180 nm and 320 nm.

64. The surface covering according to any one of claims 46 to 63 wherein further the stack of substantially parallel bilayers further includes a single outer layer comprised of a material that is substantially transparent at wavelengths between 180 nm and 320 nm and has a refractive index in the 180 nm to 320 nm range greater than the refractive index of the abutting bilayer material and the optical thickness of said outer layer is approximately one eighth of the selected wavelength.

65. The surface covering according to any one of claims 46 to 64 wherein the substrate layer is aluminum.

66. The surface covering according to any one of claims 46 to 65 wherein the substrate layer is substantially transparent at wavelengths between 400 nm and 700 nm.

67. The surface covering according to any one of claims 46 to 66 wherein the substrate layer is comprised of glass or quartz or fused silica or glass fibers.

68. The surface covering according to any one of claims 46 to 67 wherein the substrate layer includes a material that absorbs more than 20% of incident radiation for at least one wavelength between 400 nm and 700 nm.

69. The surface covering according to any one of claims 46 to 68 wherein the substrate layer further includes at least two different materials that absorb radiation between 400 nm and 700 nm differently and wherein the at least two different materials are in spatially distinct regions and where the two different materials are optionally of the same thickness.

70. The surface covering according to claim 69 wherein the spatially distinct regions are arranged to form a decorative pattern and wherein each region in the decorative pattern has a different visual appearance.

71. The surface covering according to any one of claims 46 to 70 wherein the root mean square deviation from flatness of the substrate layer over any region 1 mm×1 mm square is less than 140 nm or preferably less than 70 nm.

72. The surface covering according to any one of claims 46 to 71 wherein the surface covering is formed into individual tiles.

73. The surface covering according to claim 72 wherein the tiles have substantially identical spatial extents.

74. The surface covering according to claim 72 wherein the tiles have a plurality of different spatial extents.

75. The surface covering according to claim 72 wherein a plurality of the tiles is arranged to form a decorative pattern.

76. The surface covering according to any one of claims 46 to 75 wherein the substrate with the dielectric bilayers thereon is formed to define at least one interior surface of a room wherein the interior surface is a wall, a floor, or a ceiling.

77. The surface covering according to claim 76 wherein the reflective film is applied to at least one interior surface of a room containing thermal radiation wherein the reflective film is designed to reflect at least one wavelength of thermal (NIR) radiation. Preferably the reflective film includes a thermal insulation layer

78. The surface covering according to any one of claims 46 to 77 wherein the surface covering is formed to define at least one surface of an item of furniture or an item of equipment.

79. The surface covering according to any one of claims 46 to 78 wherein the surface covering is formed to define an aperture and radiation with wavelengths between 180 nm and 320 nm or between 700 nm and 2000 nm is transmitted through the aperture.

80. The surface covering according to any one of claims 46 to 79 wherein the surface covering is formed to define an integral light emitting device.

81. The surface covering according to any one of claims 46 to 80 wherein the surface covering is formed to define at least one integral radiation sensor operable to measure the intensity of radiation.

82. The surface covering according to any one of claims 46 to 81 wherein the surface covering is formed to define a fixture for attachment to a frame.

83. The surface covering according to any one of claims 46 to 82 wherein the surface covering is formed to define an adhesive layer on the rear surface, which may cover all or part of the surface.

84. The surface covering according to any one of claims 46 to 83 wherein the surface covering is formed to define at least one internal surface of a hospital, medical facility, nursing home, residence, commercial space, or manufacturing space.

85. The surface covering according to any one of claims 46 to 84 wherein the front surface of the substrate is fabricated to have a substantially smooth surface to minimize reflection at non-specular angles.

86. The surface covering according to claim 85 wherein the non-specular reflection amounts to less than 10% of the reflected energy and more preferably, the non-specular reflection amounts to less than 1% of the reflected energy.

87. The surface covering according to claim 85 or 86 wherein a metallic layer is placed between the smooth front surface of the substrate and the sequence of dielectric layers.

88. The surface covering according to any one of claims 85 to 87 wherein a pigment layer is placed between the smooth front surface of the substrate and the sequence of dielectric layers selected to produce a desired color effect at wavelengths in the visible region between 400 nm and 700 nm.

89. The surface covering according to any one of claims 85 to 88 wherein the smooth substrate is selected to be transparent or translucent at visible wavelengths between 400 nm and 700 nm.

90. The surface covering according to any one of claims 46 to 89 wherein a metallic layer is placed on the rear surface of the substrate.

91. The surface covering according to any one of claims 46 to 90 wherein the surface covering is formed to define a plurality of different spatial regions and at least two of said spatial regions have one layer of metal or pigment applied and wherein the metal or pigment applied to each spatial region is different where the pattern of pigments applied to different spatial regions of the substrate may generate a decorative pattern.

92. The surface covering according to any one of claims 46 to 91 wherein the surface covering is flexible and can be bent elastically with a radius of curvature at or above a threshold radius of curvature.

93. The surface covering according to claim 92 wherein the surface covering is cut to the length of a duct and a width that corresponds with the circumference of the duct and the width dimension is wound into a coil less than the cylinder radius where the coil is placed in the duct and elastically expands to conform to the duct radius.

94. The surface covering according to any one of claims 46 to 93 wherein the surface covering is rigid and substantially planar: that is the radius of curvature is greater than 10 meters or is applied to or integral with a rigid block to form a planar reflector.

95. The surface covering according to any one of claims 46 to 94 wherein the surface covering is cut into a plurality of sections and the sections are assembled abutting or nearly abutting to form a multi-faceted three dimensional optical surface.

96. The surface covering according to any one of claims 46 to 95 wherein the surface covering is formed to match and is bonded to a three dimensional surface.

97. The surface covering according to any one of claims 46 to 96 wherein a required smoothness of the substrate front surface is prepared by polishing the front surface in a lapping process wherein the substrate is attached to or integral with an optical flat so that the polishing is done relative to an optically flat two dimensional planar surface.

98. The surface covering according to any one of claims 46 to 96 wherein the substrate material is injected into a mold with optically flat surfaces where the substrate material is selected to have low viscosity to conform to the mold surface and a long setting time to minimize dimensional changes upon setting.

99. The surface covering according to any one of claims 46 to 96 wherein the required front surface smoothness is prepared by spin coating a coating material onto a substrate material wherein the coating material adheres to the substrate material and minimizes surface energy so as to produce a smooth surface.

100. The surface covering according to any one of claims 46 to 96 wherein the required smoothness of the substrate front surface may be prepared by an extrusion process wherein surface tension during the extrusion process minimizes the surface area of the substrate and hence produces a smooth surface.

101. The surface covering according to any one of claims 46 to 96 wherein the required smoothness of the substrate front surface is prepared by floating the substrate material on a liquid with a smooth surface.

102. The surface covering according to any one of claims 46 to 101 wherein the substrate material is a polymer and the polymer is selected to resist degradation by UVC radiation at and proximate to the selected wavelength between 180 nm and 320 nm.

103. The surface covering according to any one of claims 46 to 102 wherein the substrate material is a polymer and the front surface of the substrate is overlain with coating that absorbs or reflects UVC radiation between 180 nm and 320 nm such that said radiation incident on the coating layer is not incident on the polymer substrate front surface.

104. The surface covering according to any one of claims 46 to 103 wherein the stack has a first area arranged with selected thicknesses of the layers such that the incident ray of light is reflected by the stack if the angle of incidence of the ray falls within a first predetermined range of angles and is transmitted through the stack if the angle of incidence of the ray falls in a different predetermined range of angles and the stack has a second area arranged with selected thicknesses of the layers such that the incident ray of light is reflected by the stack if the angle of incidence of the ray falls within a second predetermined range of angles different from the first predetermined range of angles and is transmitted through the stack if the angle of incidence of the ray falls in a different predetermined range of angles.
